(19) United States
(12) Patent Application Publication
(10) Pub. No.: US 2016/0282661 A1
(43) Pub. Date: Sep. 29, 2016

(54) DISPLAY DEVICE

(71) Applicant: SAMSUNG DISPLAY CO., LTD., Yongin-si (KR)

(72) Inventor: Seung Wook Nam, Cheonan-si (KR)

(21) Appl. No.: 14/857,814

(22) Filed: Sep. 17, 2015

(30) Foreign Application Priority Data
Mar. 25, 2015 (KR) 10-2015-0041813

(51) Int. Cl. G02F 1/1333

(52) U.S. Cl. CPC G02F 1/133305; G02F 1/13338

(57) ABSTRACT

A display device includes a display panel, a touch sensing layer on the display panel, and a window on the touch sensing layer and coupled to the touch sensing layer by an adhesive layer, wherein the adhesive layer includes regions having different thicknesses.

### CROSS-REFERENCE TO RELATED APPLICATION

This application claims priority to and the benefit of Korean Patent Application No. 10-2015-0041813, filed in the Korean Intellectual Property Office on Mar. 25, 2015, the entire content of which is incorporated herein by reference.

### BACKGROUND

1. Field

The present invention relates to a display device.

2. Description of the Related Art

Recently, various mobile electronic apparatuses, such as a portable phone, a navigation device, a digital camera, an electronic book, a portable game console, or various kinds of terminals, to which a liquid crystal display (LCD) or an organic electroluminescent display (organic light emitting diode, OLED) is applied as a display device, have been developed.

In a general display device used in a mobile apparatus, a cover window is transparently constituted so that a user can see a display unit is provided at a front of a display panel. Because the cover window is a constitution formed at the outermost side of the device, the cover window should be strong to external impact so as to protect the display panel and the like in the apparatus.

Moreover, instead of an existing manner where a switch or a keyboard is used as an input device, recently, a structure, where a touch panel integrated with a display image is used, has come into wide use, and thus, cases where a surface of the cover window comes into contact with a finger (and/or the like) frequently occur, which may require the cover window to be of stronger hardness.

Further, recently, research of a flexible display device has been actively conducted, and it is desirable that a cover window applied to this display device be formed of a foldable member having flexibility.

The above information disclosed in this Background section is only for enhancement of understanding of the background of the invention and therefore it may contain information that does not form the prior art that is already known in this country to a person of ordinary skill in the art.

### SUMMARY

Aspects of the present invention are directed toward a foldable cover window for a display device having a surface hardness at a preset level or higher, and a display device including the same.

According to an exemplary embodiment of the present invention, there is provided a display device including: a display panel, a touch sensing layer on the display panel, and a window on the touch sensing layer and coupled to the touch sensing layer by an adhesive layer, wherein the adhesive layer includes regions having different thicknesses.

In an embodiment, the display device is a flexible device, and includes a bending region that is bendable and a flat region that is flat.

In an embodiment, a thickness of a first portion of the adhesive layer in the bending region is larger than a thickness of a second portion of the adhesive layer in the flat region.

In an embodiment, the thickness of the first portion of the adhesive layer in the bending region is about 120% to about 180% of the thickness of the second portion of the adhesive layer in the flat region.

In an embodiment, the thickness of the first portion of the adhesive layer in the bending region is about 200 μm or less.

In an embodiment, the window includes a base film, wherein a thickness of a first portion of the base film in the bending region is less than a thickness of a second portion of the base film in the flat region.

In an embodiment, the thickness of the first portion of the base film in the bending region is about 20% to about 80% of the thickness of the second portion of the base film in the flat region.

In an embodiment, the adhesive layer includes a first adhesive, and an elastic coefficient of the first adhesive is about 0.001 MPa to about 100 MPa.

In an embodiment, a material of the first adhesive includes silicon.

In an embodiment, the adhesive layer includes a second adhesive, and an elastic coefficient of the second adhesive is about 20 MPa to about 1 GPa.

In an embodiment, a material of the second adhesive includes acrylates.

In an embodiment, the adhesive layer includes the first adhesive in the bending region, and the second adhesive in the flat region.

In an embodiment, the adhesive layer includes the second adhesive in the bending region, and the first adhesive in the flat region.

In an embodiment, the adhesive layer includes the first adhesive in the bending region and the flat region.

In an embodiment, the adhesive layer includes the second adhesive in the bending region and the flat region.

In a cover window for a display device according to an exemplary embodiment of the present invention and a display device including the same, it is possible to implement a foldable cover window having a surface hardness at a preset level or more through a change of a thickness and a material of an adhesive layer.

### BRIEF DESCRIPTION OF THE DRAWINGS

FIG. 1 is a schematic cross-sectional view illustrating a flexible display device according to an exemplary embodiment of the present invention.

FIG. 2 is a schematic cross-sectional view illustrating a bending state of the flexible display device according to an exemplary embodiment of the present invention.

FIG. 3 is a schematic cross-sectional view of the display device according to an exemplary embodiment of the present invention.

FIGS. 4 to 6 are schematic cross-sectional views of a display device according to another exemplary embodiment of the present invention.

FIG. 7 is a bending stiffness graph according to an exemplary embodiment of the present invention.

FIG. 8 is a graph of a thickness of an adhesive layer according to an exemplary embodiment of the present invention.

FIG. 9 is a hardness graph according to an exemplary embodiment of the present invention.

FIG. 10 is a graph of hardness and folding levels according to an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification.

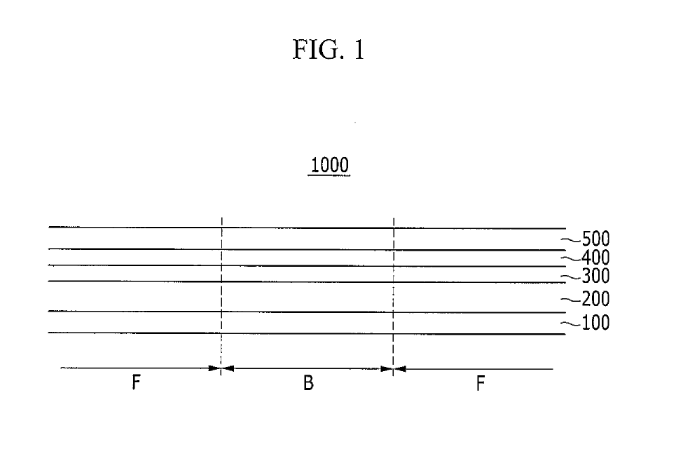

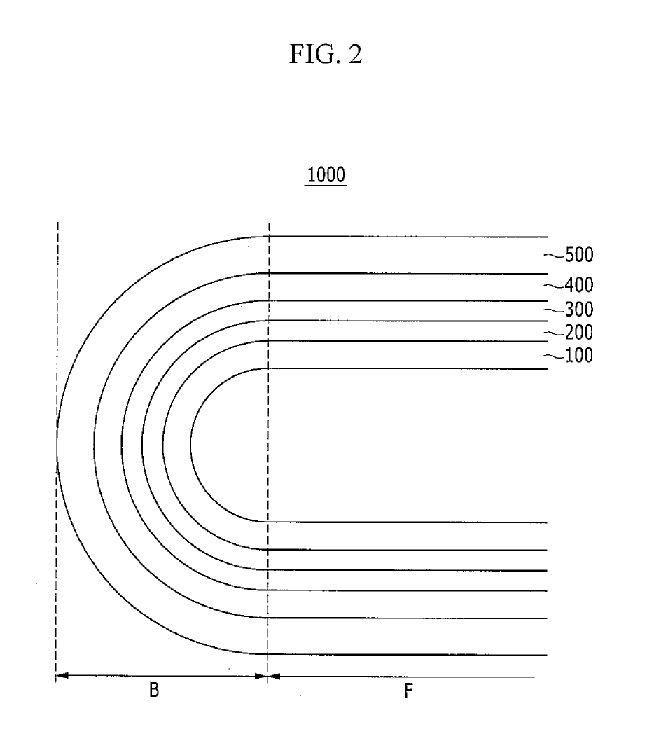

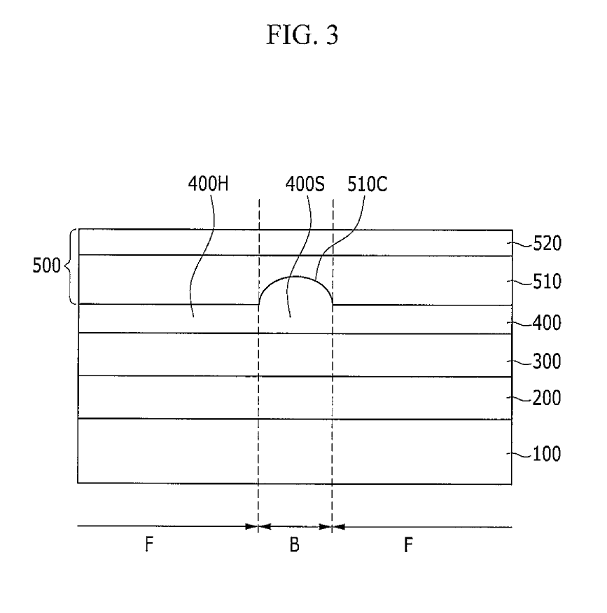

Hereinafter, a display device according to some exemplary embodiments of the present invention will be described with reference to FIGS. 1 to 3. FIG. 1 is a schematic cross-sectional view illustrating a flexible display device according to an exemplary embodiment of the present invention. FIG. 2 is a schematic cross-sectional view illustrating a bending state of the flexible display device according to an exemplary embodiment of the present invention. FIG. 3 is a schematic cross-sectional view of the display device according to an exemplary embodiment of the present invention.

First, referring to FIGS. 1 and 2, a flexible display device 1000 according to an exemplary embodiment of the present invention includes a flexible display panel 100 displaying an image, a touch sensing layer 200, a polarizing plate 300, and a cover window 500. The polarizing plate 300 and the cover window 500 may be combined by an adhesive layer 400.

The flexible display device 1000 includes a flat region F that is flat and a bending region B that is bendable.

The flexible display panel 100 includes a plurality of pixels displaying an image in the flexible display device 1000. For example, in the case where the flexible display device 1000 according to the present exemplary embodiment is a mobile terminal such as a mobile phone, an image, such as a user interface (UI) or a graphic user interface (GUI) relating to a conversation, may be displayed.

The flexible display panel 100 includes a flexible substrate formed of a plastic material having excellent heat resistance and durability, such as polyethylene naphthalate (PEN), polycarbonate (PC), polyarylate (PAR), polyether imide (PEI), polyether sulfone (PES), polyimide (PI), poly(methylmethacrylate) (PMMA), and/or the like. Further, the flexible display panel is not limited thereto, but the flexible display panel 100 may include flexible substrates formed of various suitable flexible materials.

Furthermore, the flexible display panel 100 may include a flexible substrate where a plurality of thin film transistors, a plurality of gate lines, a plurality of data lines, and a plurality of pixel electrodes are disposed, a flexible substrate where a plurality of color filters and a common electrode are disposed, and a liquid crystal layer interposed between the two substrates.

Further, the flexible display panel 100 may include a flexible substrate where a plurality of thin film transistors, a plurality of gate lines, a plurality of data lines, a plurality of pixel electrodes, and a common electrode are disposed. In this case, a microcavity is formed between the pixel electrode and the common electrode, and a liquid crystal layer may be formed in the microcavity.

Further, the flexible display panel 100 may include a plurality of thin film transistors, a plurality of gate lines, a plurality of data lines, and a plurality of organic light emitting diodes disposed on the flexible substrate.

The touch sensing layer 200 is disposed on the flexible display panel 100. The touch sensing layer 200 senses a touch. The touch sensing layer 200 may sense the touch when an object actually approaches the touch sensing layer 200 or comes into contact with the touch sensing layer 200. Herein, contact includes the case where an external object such as a user's hand comes into direct contact with the touch sensing layer 200, and the case where the external object approaches the touch sensing layer 200 or moves in an approaching state (e.g., hovering).

Furthermore, in the present exemplary embodiment, the touch sensing layer 200 is disposed on the flexible display panel 100, but is not limited thereto, and the touch sensing layer 200 may be disposed in the flexible display panel 100. Further, the touch sensing layer 200 may be positioned in the flexible substrate to be attached onto the flexible display panel 100. Further, the touch sensing layer 200 may be disposed in the window 500.

The polarizing plate 300 is disposed on the touch sensing layer 200. The polarizing plate 300 may reduce external light reflection to increase a contrast ratio of the display device.

The window 500 is disposed on the polarizing plate 300, and serves to protect the flexible display panel 100 and the touch sensing layer 200 from external force and an external contamination material.

Further, the adhesive layer 400 for attaching the window 500 may be positioned between the window 500 and the polarizing plate 300.

Further, a barrier layer absorbing an impact from the outside to reduce or prevent damage to the flexible display panel 100 and the touch sensing layer 200, due to the impact from the outside, may be positioned at a rear of the flexible display panel 100. In this case, the barrier layer may be formed of a material containing air to absorb the impact, such as a cushion or a sponge. Further, the barrier layer may serve to attach the flexible display panel 100 to other parts, for example, to the case, and in this example, the barrier layer may include the adhesive layer to be attached to the other parts.

The flexible display device 1000 has flexibility, and as illustrated in FIG. 2, may be bent. In this case, the flexible display device 1000 is bent in the bending region B.

Furthermore, in the case of the window 500, a base film formed of a plastic material is used to implement flexibility, but has durability that is weaker than that of glass, and thus it is desirable to reinforce its durability. Therefore, the thickness of the base film may be increased to reinforce durability, but in this case, there is a problem in that bending stiffness is increased to reduce flexibility of the base film. Herein, bending stiffness represents restoration force after bending.

Then, the cover window 500 according to an exemplary embodiment of the present invention and the adhesive layer 400 combining (e.g., adhering or coupling together) the cover window 500 and the polarizing plate 300 will be described in more detail with reference to FIG. 3.

FIG. 3 is a schematic view illustrating a cross-section of the window according to an exemplary embodiment of the present invention.

Referring to FIG. 3, the window 500 according to the present exemplary embodiment includes a base film (e.g., a flexible film) 510 and a hard coating layer 520.

The base film 510 is formed of a plastic film such as polyethylene terephthalate (PEF), polycarbonate (PC), polyimide (PI), poly(methylmethacrylate) (PMMA), and/or the like.

The hard coating layer 520 is formed of a material such as an organic hybrid resin, an inorganic hybrid resin, an acryl resin, and/or the like.

Although not illustrated in the present specification, a functional layer such as an anti-reflection layer preventing or substantially prevent external light from being reflected or an anti-fingerprint layer preventing or substantially prevent a user's fingerprint from remaining may be further included.

In the base film 510 according to an exemplary embodiment of the present invention, thicknesses of the bending region B and the flat region F may be different from each other. The base film 510 including a plurality of regions having different thicknesses may include a bending portion 510C.

As illustrated in FIG. 3, the thickness of the base film 510 positioned in the bending region B may be less than the thickness of the base film 510 positioned in the flat region F. As described above, the base film 510 having the different thicknesses may be manufactured by a method where the base film 510 having the different thicknesses itself is manufactured or the base film 510 positioned in the bending region B is etched according to a manufacturing process.

In this case, the thickness of the base film 510 positioned in the bending region B may be about 20% to about 80% of the thickness of the base film 510 positioned in the flat region F. This is configured in order to reduce the thickness of the base film 510 positioned in the bending region B to improve flexibility of the cover window 500 and increase the thickness of the adhesive layer positioned in the bending region B.

Next, according to an exemplary embodiment of the present invention, the polarizing plate 300 and the cover window 500 may be combined by the adhesive layer 400. Because the thicknesses of the base films 510 of the cover window 500 are different from each other, the adhesive layer 400 positioned therebetween may have regions having different thicknesses.

The adhesive layer 400 positioned in the bending region B may be thicker than the adhesive layer 400 positioned in the flat region F. That is, the adhesive layer 400 positioned in the flat region F may be formed to be thinner than the adhesive layer 400 positioned in the bending region B.

The thickness of the adhesive layer 400 positioned in the bending region B may be about 120% to about 180% of the thickness of the adhesive layer 400 positioned in the flat region F. This may be interlocked with a difference between the thicknesses of the base film 510 positioned in the bending region B and the base film 510 positioned in the flat region F. For example, the thickness of the adhesive layer 400 positioned in the bending region B may be about 200 μm or less.

As illustrated in FIG. 3, according to an exemplary embodiment of the present invention, the adhesive layer 400 may include a first adhesive 400S positioned in the bending region B and a second adhesive 400H positioned in the flat region F.

The first adhesive 400S may have an elastic coefficient that is lower than that of the second adhesive 400H. As the elastic coefficient is increased, the adhesive layer has high hardness and low elasticity, and as the elastic coefficient is reduced, the adhesive layer has low hardness and high elasticity.

That is, the first adhesive 400S positioned in the bending region B where bending of the display device occurs has high elasticity and thus provides flexibility to the cover window 500, and the second adhesive 400H positioned in the flat region F has high hardness and thus provides a preset level or more of hardness to the cover window 500.

Further, the first adhesive 400S having the relatively low elastic coefficient has slightly low adherence, and the second adhesive 400H having the relatively high elastic coefficient has slightly high adherence. In this case, because the first adhesive 400S having relatively low adherence is formed to have a large thickness as compared to the second adhesive 400H, adherence may be improved (e.g., increased). This is because as the thickness of the adhesive is increased, adherence is improved. Further, even though the second adhesive 400H having relatively high adherence is formed in a small thickness as compared to the first adhesive 400S, the second adhesive may have sufficient adherence.

In this case, the elastic coefficient of the first adhesive 400S having the relatively low elastic coefficient may be about 20 MPa to about 1 GPa. The first adhesive 400S may be any adhesive having the elastic coefficient in the aforementioned range and, for example, may be acrylates, and/or the like. The acrylate-based adhesive may include a compound represented by the following Chemical Formula 1.

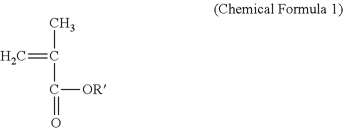

Further, the elastic coefficient of the second adhesive 400H having the relatively high elastic coefficient may be about 0.001 MPa to about 100 MPa. The second adhesive 400H may be any adhesive having the elastic coefficient in the aforementioned range and, for example, may include silicon (be silicon-based). The silicon-based adhesive may include a compound represented by the following Chemical Formula 2.

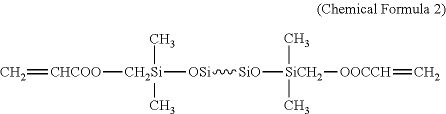

According to the aforementioned adhesive layer and cover window, flexibility may be improved (e.g., increased) in the bending region, hardness may be improved (e.g., increased) in the flat region, and a preset level of adherence may be provided according to a difference between the thicknesses of the adhesives positioned in each region, and thus quality and reliability of the display device are improved (e.g., increased).

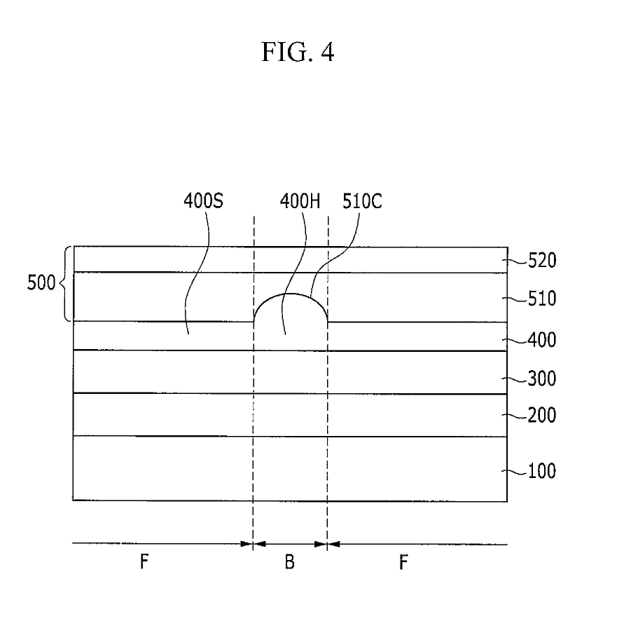

Hereinafter, a display device according to another exemplary embodiment of the present invention will be described with reference to FIGS. 4 to 6. FIGS. 4 to 6 are schematic cross-sectional views of the display device according to another exemplary embodiment of the present invention. A display panel 100, a touch sensing layer 200, and a polarization plate 300 according to another exemplary embodiment of the present invention include the same or similar constitution, and thus, hereinafter, a description thereof may not be provided.

First, referring to FIG. 4, an adhesive layer 400 and a cover window 500 according to another exemplary embodiment of the present invention will be described. The cover window 500 includes a base film 510 and a hard coating layer 520.

In the base film 510 according to another exemplary embodiment of the present invention, thicknesses of the bending region B and the flat region F may be different from each other. As illustrated in FIG. 4, the thickness of the base film 510 positioned in the bending region B may be less than the thickness of the base film 510 positioned in the flat region F. As described above, the base film 510 having the different thicknesses may be manufactured by a method where the base film 510 having the different thicknesses itself is manufactured or the base film 510 positioned in the bending region B is etched according to a manufacturing process.

In this case, the thickness of the base film 510 positioned in the bending region B may be about 20% to about 80% of the thickness of the base film 510 positioned in the flat region F. This is configured to reduce the thickness of the base film 510 positioned in the bending region B to improve flexibility of the cover window 500 and increase the thickness of the adhesive layer positioned in the bending region B.

Next, according to another exemplary embodiment of the present invention, the polarizing plate 300 and the cover window 500 may be combined by the adhesive layer 400. Because the thicknesses of the base films 510 of the cover window 500 are different from each other, the adhesive layer 400 positioned therebetween may have regions having different thicknesses.

The adhesive layer 400 positioned in the bending region B may be thicker than the adhesive layer 400 positioned in the flat region F. That is, the adhesive layer 400 positioned in the flat region F may be formed to be thinner than the adhesive layer 400 positioned in the bending region B.

The thickness of the adhesive layer 400 positioned in the bending region B may be about 120% to about 180% of the thickness of the adhesive layer 400 positioned in the flat region F. This may be interlocked with a difference between the thicknesses of the base film 510 positioned in the bending region B and the base film 510 positioned in the flat region F. For example, the thickness of the adhesive layer 400 positioned in the bending region B may be about 200 μm or less.

As illustrated in FIG. 4, according to an exemplary embodiment of the present invention, the adhesive layer 400 may include a second adhesive 400H positioned in the bending region B and a first adhesive 400S positioned in the flat region F.

The first adhesive 400S may have an elastic coefficient that is lower than that of the second adhesive 400H. As the elastic coefficient is increased, the adhesive layer has high hardness and low elasticity, and as the elastic coefficient is reduced, the adhesive layer has low hardness and high elasticity.

That is, the second adhesive 400H positioned in the bending region B where bending of the display device occurs has high hardness and thus provides a preset level of hardness to the region where bending occurs, and the first adhesive 400S positioned in the flat region F has high elasticity and thus provides a preset level or more of flexibility to the cover window 500.

Further, the first adhesive 400S having the relatively low elastic coefficient has slightly low adherence, and the second adhesive 400H having the relatively high elastic coefficient has slightly high adherence. In this case, the second adhesive 400H having the relatively high elastic coefficient has slightly high adherence, and thus a lifting phenomenon that can occur according to bending may be prevented or substantially prevented. Further, the first adhesive 400S having the relatively low elastic coefficient has low adherence as compared to the second adhesive 400H, but because the lifting phenomenon hardly occurs in the flat region F, sufficient adherence required in the device may be provided.

In this case, the elastic coefficient of the first adhesive 400S having the relatively low elastic coefficient may be about 20 MPa to about 1 GPa. The first adhesive 400S may be any adhesive having the elastic coefficient in the aforementioned range and, for example, may be acrylates. The acrylate-based adhesive may include a compound represented by the following Chemical Formula 1.

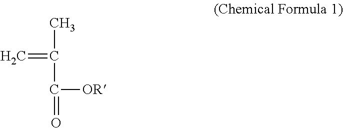

Further, the elastic coefficient of the second adhesive 400H having the relatively high elastic coefficient may be about 0.001 MPa to about 100 MPa. The second adhesive 400H may be any adhesive having the elastic coefficient in the aforementioned range and, for example, may include silicon (e.g., be silicon-based). The silicon-based adhesive may include a compound represented by the following Chemical Formula 2.

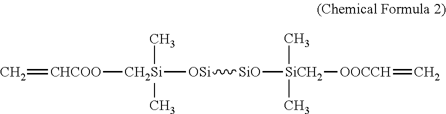

According to the aforementioned adhesive layer and cover window, the lifting phenomenon of the window and the like may be prevented or substantially prevented through provision of the adhesive layer having excellent adherence to the bending region where bending and the like occurs. Further, hardness of the cover window and the display device including the same may be improved (e.g., increased) through provision of the adhesive layer having excellent hardness to the bending region to which external force such as bending is significantly applied.

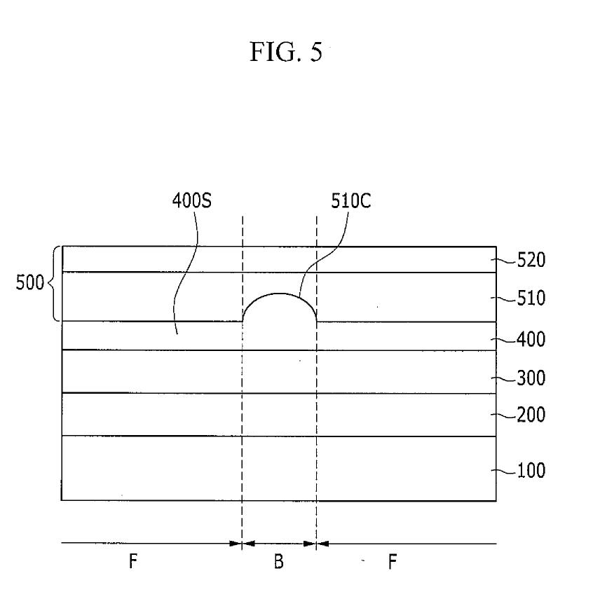

Next, referring to FIG. 5, an adhesive layer 400 and a cover window 500 according to another exemplary embodiment of the present invention will be described. The cover window 500 includes a base film 510 and a hard coating layer 520.

In the base film 510 according to another exemplary embodiment of the present invention, thicknesses of the bending region B and the flat region F may be different from each other. As illustrated in FIG. 5, the thickness of the base film 510 positioned in the bending region B may be less than the thickness of the base film 510 positioned in the flat region F. As described above, the base film 510 having the different thicknesses may be manufactured by a method where the base film 510 having the different thicknesses itself is manufactured or the base film 510 positioned in the bending region B is etched according to a manufacturing process.

In this case, the thickness of the base film 510 positioned in the bending region B may be about 20% to about 80% of the thickness of the base film 510 positioned in the flat region F. This is configured to reduce the thickness of the base film 510 positioned in the bending region B to improve flexibility of the cover window 500 and increase the thickness of the adhesive layer positioned in the bending region B.

Next, according to another exemplary embodiment of the present invention, the polarizing plate 300 and the cover window 500 may be combined by the adhesive layer 400. Because the thicknesses of the base films 510 of the cover window 500 are different from each other, the adhesive layer 400 positioned therebetween may have regions having different thicknesses.

The adhesive layer 400 positioned in the bending region B may be thicker than the adhesive layer 400 positioned in the flat region F. That is, the adhesive layer 400 positioned in the flat region F may be formed to be thinner than the adhesive layer 400 positioned in the bending region B.

The thickness of the adhesive layer 400 positioned in the bending region B may be about 120% to about 180% of the thickness of the adhesive layer 400 positioned in the flat region F. This may be interlocked with a difference between the thicknesses of the base film 510 positioned in the bending region B and the base film 510 positioned in the flat region F. For example, the thickness of the adhesive layer 400 positioned in the bending region B may be about 200 μm or less.

As illustrated in FIG. 5, according to another exemplary embodiment of the present invention, the adhesive layer 400 may include a first adhesive 400S positioned in the bending region B and the flat region F.

The elastic coefficient of the first adhesive 400S having the relatively low elastic coefficient may be about 20 MPa to about 1 GPa. The first adhesive 400S may be any adhesive having the elastic coefficient in the aforementioned range and, for example, may be acrylates. The acrylate-based adhesive may include a compound represented by the following Chemical Formula 1.

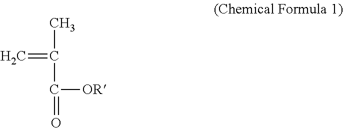

According to the adhesive layer 400 and the cover window 500 according to another exemplary embodiment of the present invention, the adhesive layer 400 includes an adhesive layer 400 including the first adhesive 400S having slightly low elastic coefficient.

In this case, because the thickness of the adhesive layer 400 positioned in the bending region B is larger than the thickness of the adhesive layer 400 positioned in the flat region F, adherence may be improved (e.g., increased) in the bending region B where a lifting phenomenon can occur. This is because in the case where the same or substantially the same kind of adhesive is used, as the thickness of the adhesive layer 400 is increased, adherence is improved.

Further, because the first adhesive 400S having the slightly low elastic coefficient has high elasticity, flexibility desired in a flexible or foldable display device may be provided.

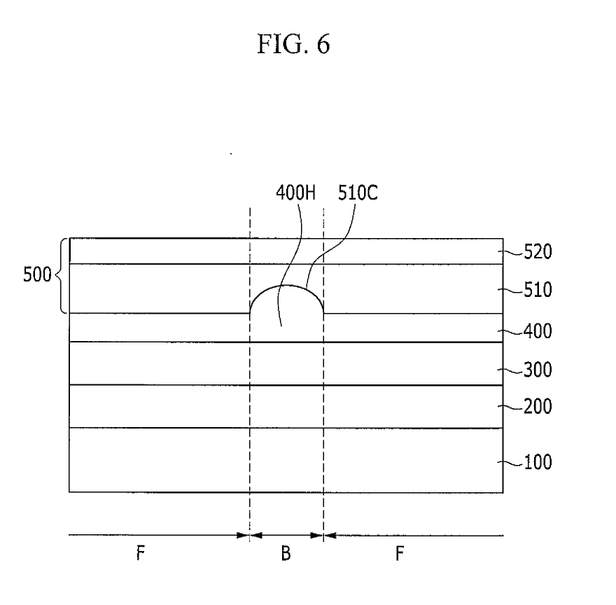

Next, the adhesive layer 400 and the cover window 500 according to another exemplary embodiment of the present invention will be described with reference to FIG. 6. The cover window 500 includes a base film 510 and a hard coating layer 520.

In the base film 510 according to another exemplary embodiment of the present invention, thicknesses of the bending region B and the flat region F may be different from each other. As illustrated in FIG. 6, the thickness of the base film 510 positioned in the bending region B may be less than the thickness of the base film 510 positioned in the flat region F. As described above, the base film 510 having the different thicknesses may be manufactured by a method where the base film 510 having the different thicknesses itself is manufactured or the base film 510 positioned in the bending region B is etched according to a manufacturing process.

In this case, the thickness of the base film 510 positioned in the bending region B may be about 20% to about 80% of the thickness of the base film 510 positioned in the flat region F. This is configured to reduce the thickness of the base film 510 positioned in the bending region B to improve flexibility of the cover window 500 and increase the thickness of the adhesive layer positioned in the bending region B.

Next, according to another exemplary embodiment of the present invention, the polarizing plate 300 and the cover window 500 may be combined by the adhesive layer 400. Because the thicknesses of the base films 510 of the cover window 500 are different from each other, the adhesive layer 400 positioned therebetween may have regions having different thicknesses.

The adhesive layer 400 positioned in the bending region B may be thicker than the adhesive layer 400 positioned in the flat region F. That is, the adhesive layer 400 positioned in the flat region F may be formed to be thinner than the adhesive layer 400 positioned in the bending region B.

The thickness of the adhesive layer 400 positioned in the bending region B may be about 120% to about 180% of the thickness of the adhesive layer 400 positioned in the flat region F. This may be interlocked with a difference between the thicknesses of the base film 510 positioned in the bending region B and the base film 510 positioned in the flat region F. For example, the thickness of the adhesive layer 400 positioned in the bending region B may be about 200 μm or less.

As illustrated in FIG. 6, according to another exemplary embodiment of the present invention, the adhesive layer 400 may include a second adhesive 400H positioned in the bending region B and the flat region F.

The elastic coefficient of the second adhesive 400H having the relatively high elastic coefficient may be about 0.001 MPa to about 100 MPa. The second adhesive 400H may be any adhesive having the elastic coefficient in the aforementioned range and, for example, may include silicon (e.g., be silicon-based). The silicon-based adhesive may include a compound represented by the following Chemical Formula 2.

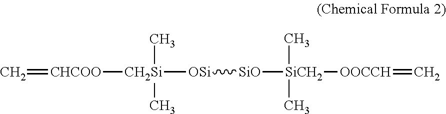

The second adhesive 400H has the relatively high elastic coefficient and thus has high hardness. Accordingly, the display device including the adhesive layer 400 including the second adhesive 400H may be strong to an external stimulus such as bending and a user's touch.

In this case, the second adhesive 400H having the relatively high elastic coefficient has slightly high adherence. Accordingly, a lifting phenomenon of the cover window 500 and the like, which may occur in the bending region B according to bending, may be prevented or substantially prevented.

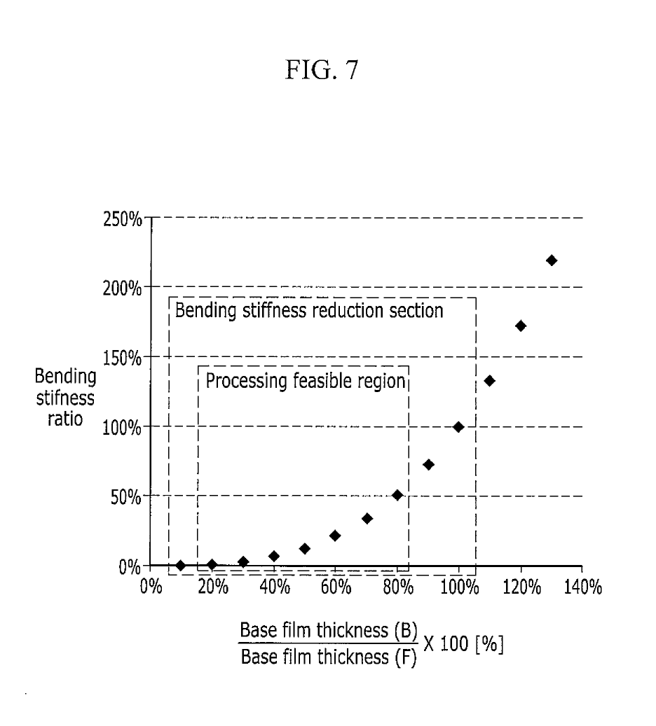

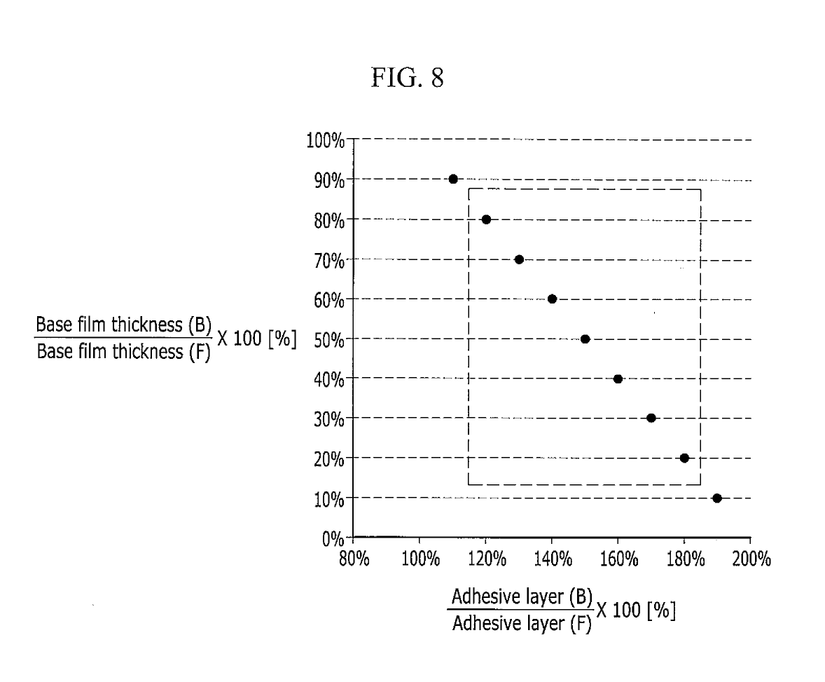

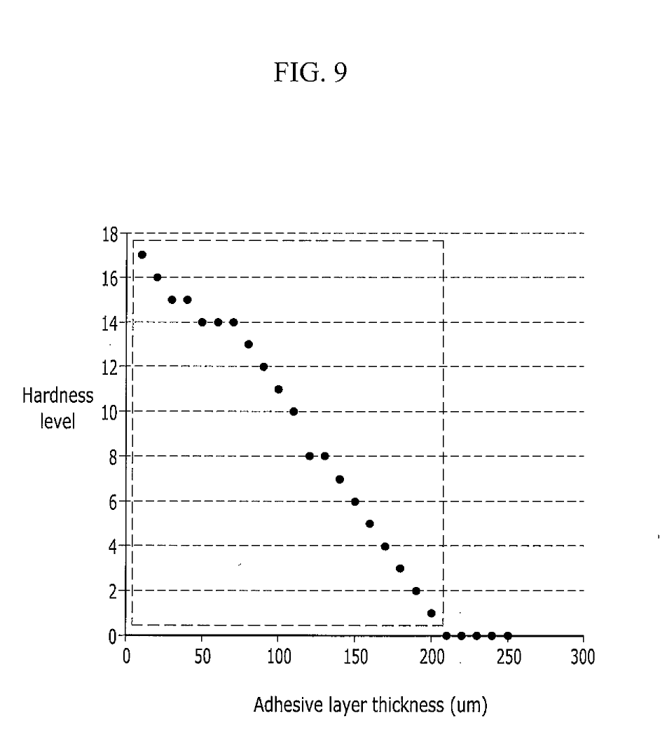

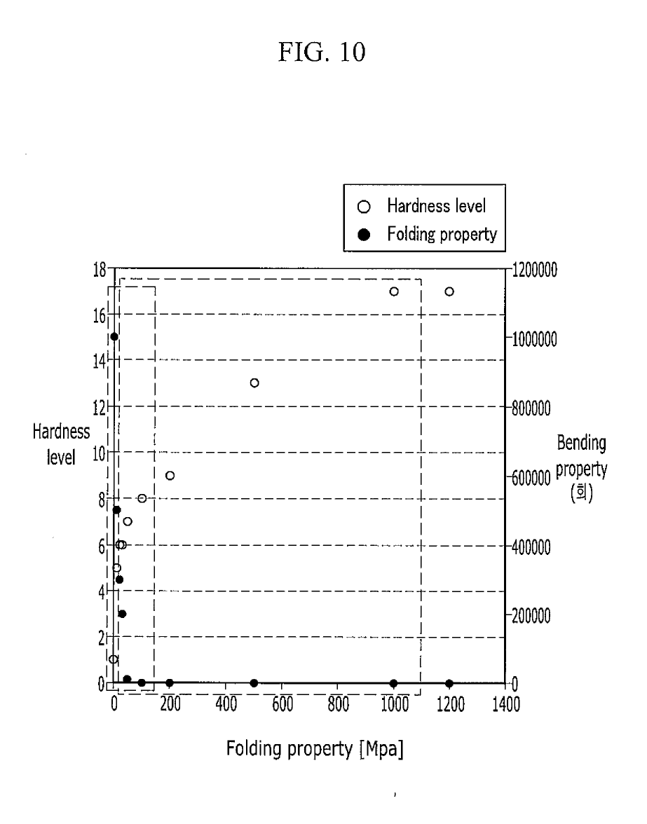

Hereinafter, an exemplary embodiments of the present invention will be described with reference to FIGS. 7 to 10. FIG. 7 is a bending stiffness graph according to an exemplary embodiment of the present invention. FIG. 8 is a graph of the thickness of the adhesive layer according to an exemplary embodiment of the present invention. FIG. 9 is a hardness graph according to an exemplary embodiment of the present invention. FIG. 10 is a graph of hardness and folding levels according to an exemplary embodiment of the present invention.

First, the bending stiffness according to the thickness of the base film positioned in the bending region according to an exemplary embodiment of the present invention will be described with reference to FIG. 7. As illustrated in FIG. 7, it can be seen that as a ratio of the thickness of the base film positioned in the bending region to the thickness of the base film positioned in the flat region is increased, the bending stiffness is increased.

In this case, in order to improve flexibility of the display device, there is an exemplary embodiment where the thickness of the base film, where a bending stiffness value is at least about 50% or less, is about 80% or less of the thickness of the base film positioned in the flat region. Further, in the case where the ratio of the thickness of the base film positioned in the flat region to the thickness of the base film positioned in the bending region is about 20% or less, it may be difficult to perform a precise manufacturing process. Therefore, like the exemplary embodiment of the present invention, in order to provide a preset level of bending stiffness while improving flexibility, the thickness of the base film positioned in the bending region may be about 20% or more to about 80% or less as compared to the thickness of the base film positioned in the flat region.

In the similar aspect, referring to FIG. 8, in the case where the ratio of the thickness of the base film positioned in the bending region to the thickness of the base film positioned in the flat region is about 20% to about 80%, in the adhesive layer coming into contact therewith, a thickness ratio of the adhesive layer positioned in the bending region to the adhesive layer positioned in the flat region is about 120% to about 180%.

Next, a hardness level according to the thickness of the adhesive layer will be described with reference to FIG. 9. According to FIG. 9, it can be seen that as the thickness of the adhesive layer is increased, hardness is reduced, and particularly, in the case where the thickness of the adhesive layer is about 200 μm or more, hardness is about 0. Accordingly, the maximum thickness of the adhesive layer may be at least about 200 μm or less, and for example, the thickness of the adhesive layer positioned in the bending region may be about 200 μm or less.

Next, the range of the elastic coefficient of the adhesive according to an exemplary embodiment of the present invention will be described with reference to FIG. 10. When it is considered that the level of hardness is about 0 to at about 18, the level of hardness of the first adhesive having the relatively low elastic coefficient is about 0 to about 9, which is an intermediate level, and the level of hardness of the second adhesive having the relatively high elastic coefficient may be about 9 to about 18.

Referring to FIG. 10, the elastic coefficient of the first adhesive having the aforementioned level of hardness may be about 0.001 MPa to about 100 MPa, and the elastic coefficient of the second adhesive may be about 20 MPa to about 1 GPa.

According to the aforementioned adhesive layer and cover window, the lifting phenomenon of the window and the like may be prevented or substantially prevented through provision of the adhesive layer having excellent adherence to the bending region where bending and the like occurs. Further, hardness of the cover window and the display device including the same may be improved (e.g., increased) through provision of the adhesive layer having excellent hardness to the bending region to which external force such as bending is significantly applied.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “lower”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to” or “coupled to” another element or layer, it can be directly on, connected to or coupled to the other element or layer, or one or more intervening elements or layers may be present. When an element or layer is referred to as being “directly on,” “directly connected to” or “directly coupled to” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include ail subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112, first paragraph, and 35 U.S.C. §132(a).

While this invention has been described in connection with what is presently considered to be practical exemplary embodiments, it is to be understood that the invention is not limited to the disclosed embodiments, but, on the contrary, is intended to cover various suitable modifications and equivalent arrangements included within the spirit and scope of the appended claims, and equivalents thereof.

Description of some of the symbols

| | |
|---|---|
| 100: Flexible display panel | 200: Touch sensing layer |
| 300: Polarization layer | 500: Window |

What is claimed is:

1. A display device comprising:
a display panel,
a touch sensing layer on the display panel, and
a window on the touch sensing layer and coupled to the touch sensing layer by an adhesive layer,
wherein the adhesive layer comprises regions having different thicknesses.

2. The display device of claim 1, wherein the display device is a flexible device, and comprises a bending region that is bendable and a flat region that is flat.

3. The display device of claim 2, wherein a thickness of a first portion of the adhesive layer in the bending region is larger than a thickness of a second portion of the adhesive layer in the flat region.

4. The display device of claim 3, wherein the thickness of the first portion of the adhesive layer in the bending region is about 120% to about 180% of the thickness of the second portion of the adhesive layer in the flat region.

5. The display device of claim 3, wherein the thickness of the first portion of the adhesive layer in the bending region is about 200 μm or less.

6. The display device of claim 2,
wherein the window comprises a base film,
wherein a thickness of a first portion of the base film in the bending region is less than a thickness of a second portion of the base film in the flat region.

7. The display device of claim 6, wherein the thickness of the first portion of the base film in the bending region is about 20% to about 80% of the thickness of the second portion of the base film in the flat region.

8. The display device of claim 7, wherein the adhesive layer comprises a first adhesive, and an elastic coefficient of the first adhesive is about 0.001 MPa to about 100 MPa.

9. The display device of claim 8, wherein a material of the first adhesive comprises silicon.

10. The display device of claim 8, wherein the adhesive layer comprises a second adhesive, and an elastic coefficient of the second adhesive is about 20 MPa to about 1 GPa.

11. The display device of claim 10, wherein a material of the second adhesive comprises acrylates.

12. The display device of claim 10, wherein the adhesive layer comprises the first adhesive in the bending region, and the second adhesive in the flat region.

13. The display device of claim 10, wherein the adhesive layer comprises the second adhesive in the bending region, and the first adhesive in the flat region.

14. The display device of claim 10, wherein the adhesive layer comprises the first adhesive in the bending region and the flat region.

15. The display device of claim 10, wherein the adhesive layer comprises the second adhesive in the bending region and the flat region.
